(19) United States
(12) Patent Application Publication
(10) Pub. No.: US 2021/0218573 A1
(43) Pub. Date: Jul. 15, 2021

(54) NON-TRANSFERRED IDENTIFICATION SYSTEM USING SCRAMBLING TWO DIMENSIONAL CODE

(71) Applicant: Shing Kwong Fung, Tsuen Wan (CN)

(72) Inventor: Shing Kwong Fung, Tsuen Wan (CN)

(21) Appl. No.: 16/739,123

(22) Filed: Jan. 10, 2020

(51) Int. Cl. H04L 9/32; G06K 19/06

(52) U.S. Cl. CPC H04L 9/3226; G06K 19/06037

(57) ABSTRACT

A non-transferred identification system using scrambling two dimensional code is provided. A code transfer website is used to transfer 2D code by a scrambling way and is obtained from the original used communication path or software, no other software, APP, or the communication paths are needed to be download or built for obtaining the code transfer website. The 2D codes are scrambled and varied from time to time. Users do not need to worry about that the 2D code is copied illegally to cause a wrong identification of the user. Furthermore, a validation time period is provided so that the identification is time limited. Besides, the code transfer website is connected to a specific electronic communication device by using a dedicate device code so that the code transfer website cannot be used by another mobile phone. It is very difficult to be used illegally.

### FIELD OF THE INVENTION

The present invention is related to electronic identification, and in particular to a non-transferred identification system using scrambling two dimensional code.

### BACKGROUND OF THE INVENTION

2D codes (two dimensional code, such as QR codes) serve to store specific information. The 2D codes are attached to some objects for identification. Currently, 2D codes are widely used in identification of specific persons, such as using a mobile phone APP to generate a specific 2D code which represent a message about an identify of a user. If the 2D code is scanned by an electronic device, the user may be identified.

Many checkpoints are currently controlled by using 2D codes to identify the person requesting to pass therethrough, for example, doors for offices, lockers, usages of electronic devices, such as computers, tablets, etc., or using of some machines. In identification of a person, the conventional 2D code has a specific form for a specific person for identification of a person. If this 2D code is copied undesired by another person, this person can pass through the identification of this code so that the identification system considers that the another person copied the 2D code is one which are lawfully authorized. This is not beneficial for control of persons and it is a threatening to the safety of the system.

Therefore, inventor of the present invention desires to provide a novel non-transferred identification system using scrambling two dimensional code, which can resolve the problems in the prior art.

### SUMMARY OF THE INVENTION

Accordingly, for improving above mentioned defects in the prior art, the object of the present invention is to provide a a non-transferred identification system using scrambling two dimensional code, wherein a code transfer website is used to transfer 2D code by a scrambling way and is get from the original used communication path or software, no other software, APP, or the communication paths are needed to be download or built for obtaining the code transfer website. Therefore, it is convenient and is suitable to the habits of the users. Furthermore, the 2D codes are scrambled and varied from time to time. Users do not need to worry about that the 2D code is copied illegally so that identification of the user is wrong. Furthermore the validation time period is provided so that the identification is time limited. This kind of 2D code is suitable for various usages, such as door control for an office, a locker, a refrigerator, an electronic device, a machine, etc. Besides, the code transfer website is connected to a specific electronic communication device by using the device code so that the code transfer website cannot be used by another mobile phone. It is very difficult to be used illegally.

To achieve above object, the present invention provides a non-transferred identification system using scrambling two dimensional code, comprising: a server for transferring a code transfer website to an external electronic communication device; wherein transfer of the code transfer website is unnecessary to download any communication software for transferring of the code transfer website; and thus the user is unnecessary to download other software for transfer of the code transfer website; wherein the server is built with a scramble coder; the server is stored with an identification data set and a scramble variable; the identification data set contains an identification ID, a validation time period and the current time of the server; the identification ID serves to identify a specific object; after identification; wherein the server stores a scramble variable; the scramble coder encodes the identification code, the validation time period, and the current time of the server of the identification data set by using the scramble variable and then the encoded codes are changed as a 2D code; the 2D code only retains through a finite time period which is the validation time period; after a finite time, the 2D code is changed as another 2D code; from time to time this process is repeated until a preset time is elapsed so that we mean that the 2D code is scrambled; and an electronic communication device for receiving the code transfer website from the server; when the electronic communication device is connected to the server through the code transfer website, the server generates the 2D code by the scrambling way and transfers the 2D code to the electronic communication device; wherein the server further comprises a database for storing the code transfer website and the identification data set.

The non-transferred identification system further comprises a decoding receiver installed in a specific position for receiving the 2D codes from the electronic communication device; and a scramble decoder electrically connected to the decoding receiver; the scramble decoder being arranged on the specific position or at the server; the scramble decoder containing the scramble variable, and other variables related to the scramble variable; the scramble decoder receives the 2D code from the decoding receiver and decodes the 2D code so as to get the identification code, the validation time period, and the current time of the server with respect to the identification data set; wherein the scramble decoder decides whether the current time is within the current time of the server pluses the validation time period; if not, it is considered that the 2D code is ineffective, no proceeding work is performed; while if yes, the proceeding work is done.

### BRIEF DESCRIPTION OF THE DRAWINGS

FIG. 1 is a structural block diagram of the present invention.

FIG. 2 is another structural block diagram of the present invention.

FIG. 3 is a schematic view showing that the current time for decoding is within a validation time period.

FIG. 4 is a schematic view showing that the current time for decoding is not within a validation time period.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

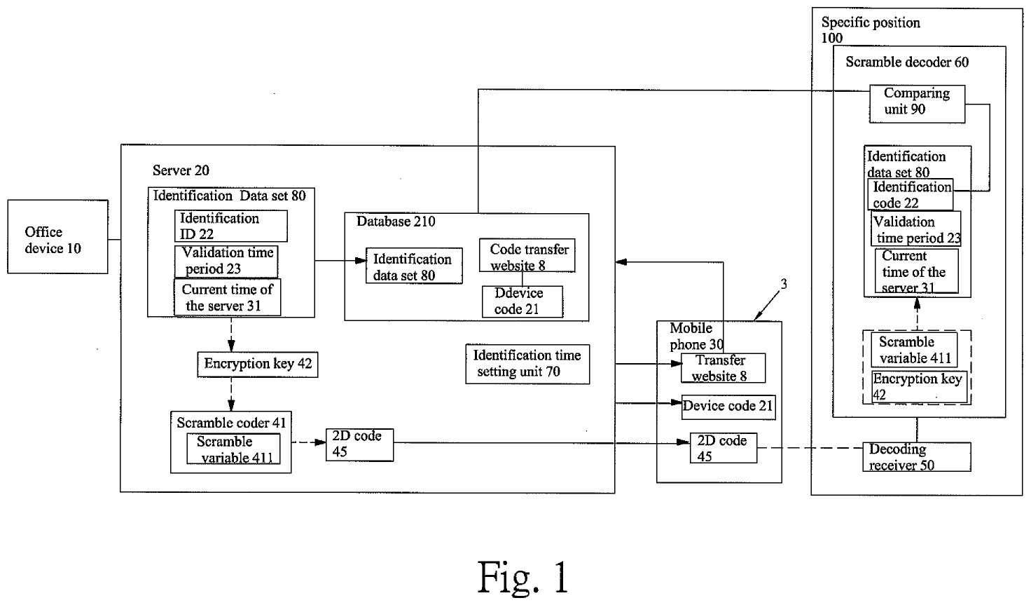

With reference to FIGS. 1 to 4, the structure of the present invention is illustrated. The system of the present invention can be used in various communication system, such as 2G, 3G, 4G, 5G, WiFi, Bluetooth, NFC, etc.

A server 20 serves for transferring a code transfer website 8 to an external electronic communication device 3 which is such as a mobile phone, a PDA (personal digital assistant), a desktop computer, a tablet computer, a notebook computer, etc. Here, a mobile phone is used for description of the invention, but it is not used to confine the scope of the present invention. The code transfer website 8 transfers data by other ways for communication. It is unnecessary to download any communication software for transferring of the code transfer website 8, such as an APP. The other ways for communication are such as short messages, emails, social media (such as a facebook, QQ, instagram, etc.), talk software (such as Line, wechat, etc.), which are existed originally in the electronic communication device 3, and thus the user is unnecessary to download other software for transferring of the code transfer website 8. Therefore, the user can get the code transfer website 8 very easily and conveniently.

The server 20 is built with a scramble coder 41. The server 20 is stored with an identification data set 80, an encryption key 42 and a scramble variable 411. The encryption key 42 is related to the related identification data set 80. The identification data set 80 contains an identification ID 22, a validation time period 23 and the current time of the server 31. The identification ID serves to identify a specific object (for example, a person). After identification, the proceeding works can be done, such as opening a door or let someone to pass through a checkpoint or into a website, etc.

The server 20 also stores a scramble variable 411. The serves 20 encrypts the identification code 22, the validation time period 23, and the current time of the server 31 of the identification data set 80 by using the encryption key 42 to get a plurality of encrypted values. Then the scramble coder 41 encodes the encrypted values by using the scramble variable 411 and then the encoding codes are changed as a 2D code 45 (such as a QR code). The 2D code 45 is scrambled and only retains through a finite time period. After a finite time, the 2D code 45 is changed as another 2D code 45. From time to time, this process is repeated until a preset time so that we mean that the 2D code 45 is scrambled. The abovesaid finite time is the validation time period 23. The 2D code 45 is codes of any form, such as a QR codes, or a bar code, etc.

In this example, the electronic communication device 3 is a mobile phone 30 for receiving the code transfer website 8 from the server 20. When the mobile phone 30 is connected to the server 20 through the code transfer website 8, the server 20 generates the 2D code 45 by the scrambling way and transfers the 2D code 45 to the mobile phone 30.

The server 20 further comprises a database 210 for storing the code transfer website 8 and the identification data set 80.

When initially, the mobile phone 30 is connected to the server 20 through the code transfer website 8, the server 20 will transfer a device code 21 to the mobile phone 30 by using the code transfer website 8. The device code 21 is stored in the mobile phone 30.

Similarly, the server 20 stores the device code 21 of the mobile phone 30 in the database 210 thereof and make relation between the device code 21 and the code transfer website 8. Then this device code 21 is not transferred to any other mobile phone. Therefore, other mobile phone cannot be connected to the server 20 by using this code transfer website 8 even the mobile phone 30 transfers this code transfer website 8 to another mobile phone. This is because this device code 21 is not stored in the another mobile phone. That is, if another mobile phone 30 will connect to the server 20 through this code transfer website 8, the server 20 will identify whether the another mobile phone 30 having the device code 21 related to this code transfer website 8. Thus, the server 20 will not transfer any 2D code 45 to the another mobile phone.

For example, the identification code 22 is ABC, the validation time period 23 is 10 seconds, and the current time of the server 31 is 120315 (3 minutes and 15 seconds at 12 O'clock). The master key 42 is A01C78; and the scrambling variable 411 is the sequential combination of number of hours, minutes and seconds. The server 20 encrypts the ABC, 10 second, and 120315 by using the master key 42 (A01C78). The scrambling coder 41 codes the encrypted data. The coding operation is performed every 10 seconds. The coding is effected by the scrambling variable 411.

A decoding receiver 50 is installed in a specific position 100 for receiving the 2D codes 45 from the mobile phone 30.

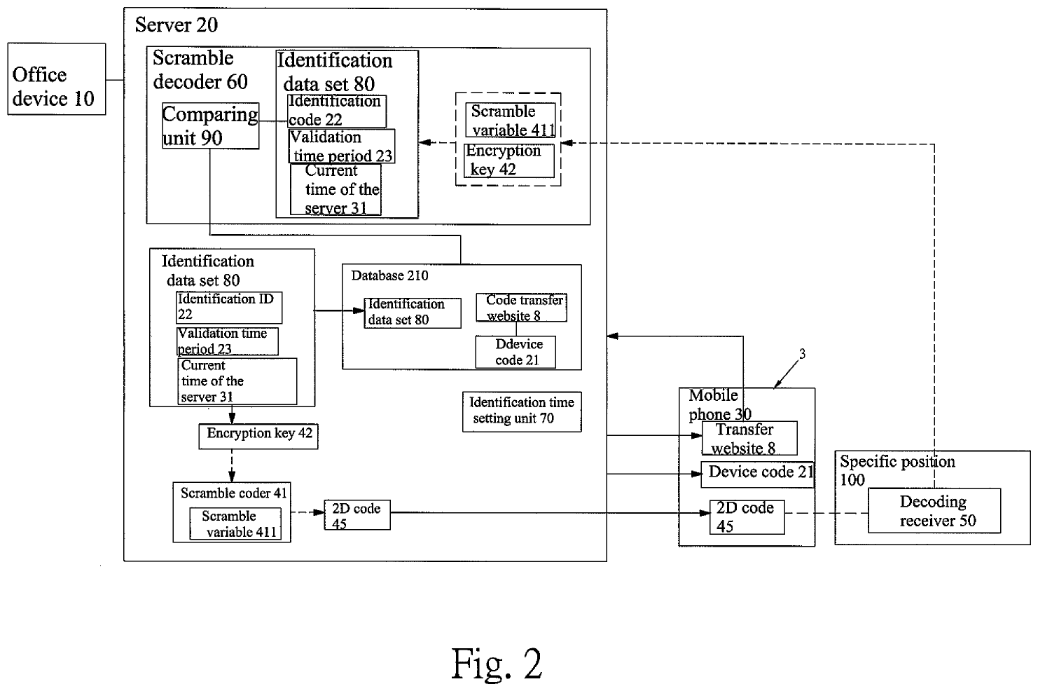

A scramble decoder 60 is electrically connected to the decoding receiver 50. The scramble decoder 60 is arranged on the specific position 100 (referring to FIG. 1) or at the server 20 (see FIG. 2). The scramble decoder 60 contains the scramble variable 411, other variables related to the scramble variable 411, and the encryption key 42. For a specific identification data set 80, the encryption key 42 of the scramble decoder 60 is identical to the encryption key 42 in the server 20. The scramble decoder 60 receives the 2D code 45 from the decoding receiver 50 and decodes the 2D code 45 and decrypts then by using the encryption key 42 so as to get the identification code 22, the validation time period 23, and the current time of the server 31 with respect to the identification data set 80.

The scramble decoder 60 decides whether the current time is within the current time of the server 31 plus the validation time period 23 which is called as an effective time. For example, when the validation time period 23 is 10 seconds and the current time of the server 31 is 15 seconds and 3 minutes of 12 o'clock, the scramble decoder 60 determine whether the current time is within a time period between 15 seconds and 3 minutes of 12 o'clock and 25 seconds and 3 minutes of 12 o'clock.

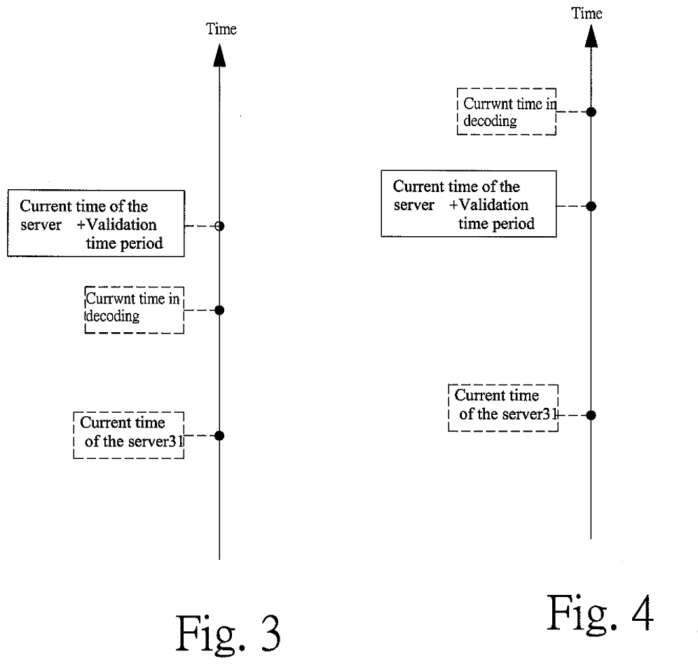

Referring to FIG. 4, when the current time acquired by the scramble decoder 60 is not within the effective time, it is considered that the time for the decoding receiver 50 to scan the mobile phone 30 has over the validation time, and thus the 2D code 45 is ineffective, and thus no proceeding work is performed. With reference to FIG. 3, when the current time decoded is within the effective time, the proceeding work is done.

In the present invention, the scramble decoder 60 further comprises a comparing unit 90 for identifying the identification code 22. The comparing unit 90 is electrically connected to the database 210 of the server 20. The comparing unit 90 identifies the identification code 22 to assure that the identification code 22 is acceptable. That is, the person holding the mobile phone 30 is identified and acceptable, otherwise, the person is not acceptable.

When the scramble decoder 60 is positioned in the specific position 100, the comparing unit 90 made a backup copy about the database 210 of the server 20. If no network connection, the comparing unit 90 can still perform the identification work to the identification code 22 so as to perform the identification of the holder of the mobile phone 30.

In above description, the server 20 and the decoding receiver 50 must be synchronous. The synchronous time is easily built, for example, the server 20 and the decoding receiver 50 are connected to the same clock.

The scramble variable 411 and other variables related to the scramble variable 411 are variables which can be easily get by the scramble decoder 60, for example, the scramble variable 411 are hour, minutes, seconds of current time.

The present invention further comprises an identification time setting unit 70 which is positioned in the server 20 for setting a time period or time allowable for the code transfer website 8 to transfer 2D code 45 to the mobile phone 30. When the time is out of the time period or time, the code transfer website 8 will not transfer 2D code 45 to the mobile phone 30. That is to say, the holder of the mobile phone 30 cannot be identified by the server 20.

In the present invention, the server 20 can be connected to an office device 10. When the mobile phone 30 desires to get the code transfer website 8 from the server 20, it emits a request to the office device 10. Then the office device 10 instructs the server 20 to transfer the code transfer website 8 to the mobile phone 30.

Advantages of the present invention are that: the code transfer website 8 is get from the original used communication path or software, no other software, APP, or the communication paths are needed to be download or built for obtaining the code transfer website. Therefore, it is convenient and is suitable to the habits of the users. Furthermore in the present invention, the 2D codes are scrambled and varied from time to time. Users do not need to worry about that the 2D code is copied illegally so that identification of the user is wrong. Furthermore the validation time period is provided so that the identification is time limited. This kind of 2D code is suitable for various usages, such as door control for an office, a locker, a refrigerator, an electronic device, a machine, etc. Besides, in the present invention, the code transfer website is connected to a specific mobile phone by using the device code so that the code transfer website cannot be used by another mobile phone. It is very difficult to be used illegally.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A non-transferred identification system using scrambling two dimensional code, comprising:
a server for transferring a code transfer website to an external electronic communication device; wherein transfer of the code transfer website is unnecessary to download any communication software for transferring of the code transfer website; and thus the user is unnecessary to download other software for transfer of the code transfer website; wherein the server is built with a scramble coder; the server is stored with an identification data set and a scramble variable; the identification data set contains an identification ID, a validation time period and the current time of the server; the identification ID serves to identify a specific object; after identification;
wherein the server stores a scramble variable; the scramble coder encodes the identification code, the validation time period, and the current time of the server of the identification data set by using the scramble variable and then the encoded codes are changed as a 2D code; the 2D code only retains through a finite time period which is the validation time period; after a finite time, the 2D code is changed as another 2D code; from time to time this process is repeated until a preset time is elapsed so that we mean that the 2D code is scrambled; and
an electronic communication device for receiving the code transfer website from the server; when the electronic communication device is connected to the server through the code transfer website, the server generates the 2D code by the scrambling way and transfers the 2D code to the electronic communication device; and
wherein the server further comprises a database for storing the code transfer website and the identification data set.

2. The non-transferred identification system of claim 1, wherein initially, the electronic communication device is connected to the server through the code transfer website, the server transfers a device code to the electronic communication device by using the code transfer website; and the device code is stored in the electronic communication device; and moreover the server 20 stores the device code of the electronic communication device and make relation between the device code and the code transfer website; then this device code is not transferred to any other electronic communication device; any other electronic communication device cannot be connected to the server 20 by using this code transfer website even the electronic communication device transfers this code transfer website to another electronic communication device.

3. The non-transferred identification system of claim 1, further comprising:
a decoding receiver installed in a specific position for receiving the 2D codes from the electronic communication device; and
a scramble decoder electrically connected to the decoding receiver; the scramble decoder being arranged on the specific position or at the server;
the scramble decoder containing the scramble variable, and other variables related to the scramble variable; the scramble decoder receives the 2D code from the decoding receiver and decodes the 2D code so as to get the identification code, the validation time period, and the current time of the server with respect to the identification data set;
wherein the scramble decoder decides whether the current time is within the current time of the server pluses the validation time period; if not, it is considered that the 2D code is ineffective, no proceeding work is performed; while if yes, the proceeding work is done.

4. The non-transferred identification system of claim 3, wherein the server is stored with an encryption key; before the scramble coder encodes the identification data set; the serves encrypts the identification code, the validation time period, and the current time of the server of the identification data set by using the encryption key to get a plurality of encrypted values for being encoded by the scramble coder; and
the scramble coder further stores with the encryption key; for a specific identification data set, the encryption key of the scramble decoder is identical to the encryption key of the specific identification data set in the server; after the scramble decoder receives the 2D code from the decoding receiver and decodes the 2D code, the scramble coder decrypts the decoded 2D code by using the encryption key for obtaining the identification code, the validation time period, and the current time of the identification data set.

5. The non-transferred identification system of claim 3, wherein the scramble decoder further comprises a comparing unit for identifying the identification code; the comparing unit is electrically connected to the database of the server; the comparing unit identifies the identification code to assure that the identification code is acceptable.

6. The non-transferred identification system of claim 1, wherein ways for transferring the code transfer website is one of short messages, emails, social media, talkative software, which are existed originally in the electronic communication device, no further software is needed to be downloaded for transferring of the code transfer website.

7. The non-transferred identification system of claim 5, wherein when the scramble decoder is positioned in the specific position, the comparing unit makes a backup copy about the database of the server; if no network connection, the comparing unit still performs the identification work to the identification code.

8. The non-transferred identification system of claim 3, wherein the scramble variable and other variables related to the scramble variable are variables which can be easily obtained by the scramble decoder.

9. The non-transferred identification system of claim 1, wherein the scramble variable are variables relating to time.

10. The non-transferred identification system of claim 1, wherein the scramble variable are hour, minutes, seconds of current time.

11. The non-transferred identification system of claim 1, further comprising an identification time setting unit which is positioned in the server for setting a time period or time allowable for the code transfer website to transfer 2D code to the mobile phone; when the time is out of the time period or time, the code transfer website will not transfer 2D code to the mobile phone.

12. The non-transferred identification system of claim 1, wherein the 2D code 45 is QR codes or a bar code

13. The non-transferred identification system of claim 1, wherein the electronic communication device is one of a mobile phone, a PDA, a desktop computer, a tablet computer, and a notebook computer.

14. The non-transferred identification system of claim 1, wherein the identification code is used for opening a door, letting someone to pass through a checkpoint, identification of an ID of a person, entering into a website, or to use a specific object.
